(19) United States
(12) Patent Application Publication
(10) Pub. No.: US 2005/0120692 A1
(43) Pub. Date: Jun. 9, 2005

(54) Leaf monster

(76) Inventor: Young Beom Kim, Edison, NJ (US)

Correspondence Address: YOUNG BEOM KIM, 263 WHITE BIRCH RD, EDISON, NJ, 08837, US

(21) Appl. No.: 10/901,777

(22) Filed: Jul. 29, 2004

Related U.S. Application Data
(60) Provisional application No. 60/526,871, filed on Dec. 4, 2003.

(51) Int. Cl. A01D 1/00

(52) U.S. Cl. 56/1

(57) ABSTRACT

A two dimensional leaf collection woven net for collecting leaves. A woven net including a two-dimensional woven mesh net having an outer periphery. The woven mesh net having mesh openings of ½″×½″ to 1½″×1½″. The woven mesh net is formed of biodegradable fiber material. The woven mesh net also includes a continuous pulling strand extending about the outer periphery of the woven mesh net; and the continuous pulling strand is used for pulling a strand section at various locations about the outer periphery to form the woven mesh net into a disposable woven net bag.

### FIELD OF THE INVENTION

The present invention relates to a two-dimensional, biodegradable leaf collection woven net for the collection of fallen leaves thereon. More particularly, the leaf collection woven net includes a continuous pulling strand for pulling a strand section at various locations about an outer periphery of a woven mesh net that forms a disposable woven net bag having fallen leaves within an interior compartment therein.

### BACKGROUND OF THE INVENTION

Every year, autumn leaves fall on the lawns of beautiful homes and commercial businesses, creating many problems as a result of the fallen leaves, such as, destruction of the lawn, piling up against the house, the fallen leaves flying around onto the driveway and street, and the like. Each homeowner or gardener typically uses a blower or rake and garbage bags to collect these leaves, only to find more leaves accumulated after the tedious chore is completed, as leaf collection is very hard and time-consuming work. Some homeowners or gardeners might be tempted to use big plastic sheeting to collect autumn leaves, but this could result in destroying the lawn by smothering it. Plastic sheeting is also very heavy and awkward to use. There remains a need for a leaf collection net that would help the homeowner or gardener to make the task of autumn lawn maintenance easy and convenient. More particularly, a biodegradable woven mesh net to collect the leaves, as the mesh net is very light in weight and does not block sunlight to the grass or greenery it might cover.

### DESCRIPTION OF THE PRIOR ART

Leaf catching and collection devices, lawn debris devices, lawn nets and the like having various designs, structures, configurations and materials of construction have been disclosed in the prior art. For example, U.S. Pat. No., 4,366,949 to STAUB, SR. discloses a leaf caching and collecting device and method for use are provided including post members to be driven into the ground and extend above the ground with hooks on the post to receive one edge of a flexible netting which is laid over the ground and held to the ground by hooks along the leading edge toward the source of the leaves and after the leaves collect on the netting, it is unhooked and the leaves gathered in the netting for discard. This prior art patent does not disclose or teach the design, structure and configuration of the leaf collection woven net of the present invention.

U.S. Pat. No. 4,602,664 to HULLEN discloses an apparatus for collecting lawn debris. Flat pieces of netting material are placed on the ground to catch leaves as they fall from nearby trees. When the leaves have fallen the net blanket is bundled up into a net package for disposal. The packages may or may not require a bag closure. A novel net bag closure for such packages is also disclosed. The bag closure also forms a handle for carrying the bundled leaf package. The net blankets may also be hung fro trees to catch the leaves thereof before they reach the ground. The netting may be folded and then rolled onto a hollow tube for merchandising, with accessories contained the hollow tube. The prior art patent does not disclose or teach the design, structure and configuration of the leaf collection woven net of the present invention.

U.S. Pat. No. 5,417,462 to HENSLEY discloses a lawn net for capturing and retaining lawn debris. The lawn net is positioned upon a lawn for colleting leaves thereon without harming the lawn. The device includes a netting material which may be left on the lawn for an extended period of time whiles leaves fall onto the net from surrounding trees. The net may be gathered together to enclosed the leaves by a use of a cord disposed along a periphery of the netting material. The net further includes a dispensing assembly for applying insecticide or fertilizer compounds to the lawn and is also provided with an adhesive applicator for applying an adhesive to the netting material prior to its placement upon the lawn. This prior art patent does not disclose or teach the design, structure and configuration of the leaf collection woven net of the present invention.

U.S. Pat. No. 5,744,212 to MEEKS discloses an apparatus and method for gathering and removing yard waste. The apparatus includes two parts, a laminar sheet and a plurality of spikes. The laminar sheet is placed on the ground and secured using the spikes. A number of apertures pierce the sheet to allow oxygen to aspirate the plant life below and to allow water from above to pass through. Clear plastic is preferably used to allow sunlight to reach the plant life, but other colors and materials are possible if so desired. After leaves, tree limbs, and other year waste have accumulated on the sheet, the spikes may-be removed from the ground and the sheet and waste may be bundled together and discarded. This prior art patent does not disclose or teach the design, structure and configuration of the leaf collection woven net of the present invention.

None of these prior art patents teach or disclose the structure of a two dimensional, flat biodegradable leaf collection woven net having a continuous pulling strand that is used for pulling a strand section at various locations to form the woven mesh net into a disposable woven net bag.

Accordingly, it is an object of the present invention to provide a leaf collection woven net for the collection of fallen leaves that has a pulling strand for pulling a strand section at various locations about the outer periphery of a woven mesh net that forms a disposable woven net bag having fallen leaves within an interior compartment therein.

Another object of the present invention is to provide a leaf collection woven net that has a continuous pulling strand being a different color from that of the woven mesh net in order to easily identify the continuous pulling strand when the user needs to pull the various strand sections together in the process of collecting and harvesting the fallen leaves.

Another object of the present invention is to provide a leaf collection woven net that is made from biodegradable materials such as jute, hemp, abaca, cotton, wood fibers, plant fibers and combinations thereof.

Another object of the present invention is to provide a leaf collection woven net that uses a vertically oriented leaf blocking net in combination with the woven net for preventing the blowing away of additional or stray leaves on the woven net when using gas leaf blower or an electric air leaf blower during leaf collection.

Another object of the present invention is to provide a leaf collection woven net when in a fully assembled state having fallen leaves therein wherein each of the disposable woven net bags are stackable with each other.

Another object of the present invention is to provide a leaf collection woven net that is easy to assemble and use with only one moving part (the continuous pulling strand) for harvesting of the fallen leaves on the woven mesh net.

Another object of the present invention is to provide a leaf collection woven net that can be mass produced in an automated and economical manner and is readily affordable by the user.

### SUMMARY OF THE INVENTION

In accordance with the present invention, there is provided a two dimensional leaf collection woven net for collecting leaves. The woven net includes a two-dimensional woven mesh net having an outer periphery. The woven mesh net having mesh openings of ½″×½″ to 1½″×1½″. The woven mesh net is formed of biodegradable fiber material. The woven mesh net also includes a continuous pulling strand extending about the outer periphery of the woven mesh net; and the continuous pulling strand is used for pulling a strand section at various locations about the outer periphery to form the woven mesh net-into a disposable woven net bag.

### BRIEF DESCRIPTION OF DRAWINGS

Further objects, features and advantages of the present invention will become apparent upon the consideration of the following detailed description of the presently preferred embodiment when taken in conjunction with the accompanying drawings, wherein:

FIG. 1 is a top plan view of the leaf collection net of the preferred embodiment of the present invention showing the major component parts contained therein and in an assembled state being readied for operational use thereof;

FIG. 1A is a top plain view of the leaf collection net of the alternate embodiment of the present invention showing a circular configuration of the woven net;

FIG. 2 is an enlarged partial top plan view of the leaf collection net of the present invention showing a woven net, a continuous pulling strand and a plurality of net pegs;

FIG. 3 is a top perspective view of the leaf collection net of the present invention showing a multitude of leaves being raked and/or air blown onto the woven net;

FIG. 4 is a top perspective view of the leaf collection net of the present invention showing four strand sections of the continuous pulling strand being pulled together to form a partial interior compartment for holding the leaves within the woven net;

FIG. 5 is a top perspective view of the leaf collection-net of the present invention showing eight strand sections of the continuous pulling strand being pulled together to form the partial interior compartment for holding the leaves within the woven net;

FIG. 6 is a top perspective view of the leaf collection net of the present invention showing twelve strand sections of the continuous pulling strand being pulled together to form a complete interior compartment for holding all of the leaves within the woven net;

FIG. 7 is a top perspective view of the leaf collection net of the present invention showing the multiple strand sections of the continuous pulling strand pulled together to form a leaf collection net bag for holding all of the leaves within the interior compartment; and

FIG. 8 is a top perspective view of the leaf collection net of the present invention showing a plurality of full leaf collection net bags piled and stacked on top of each other for disposal.

### DETAILED DESCRIPTION OF THE PREFERRED EMBODIMENT

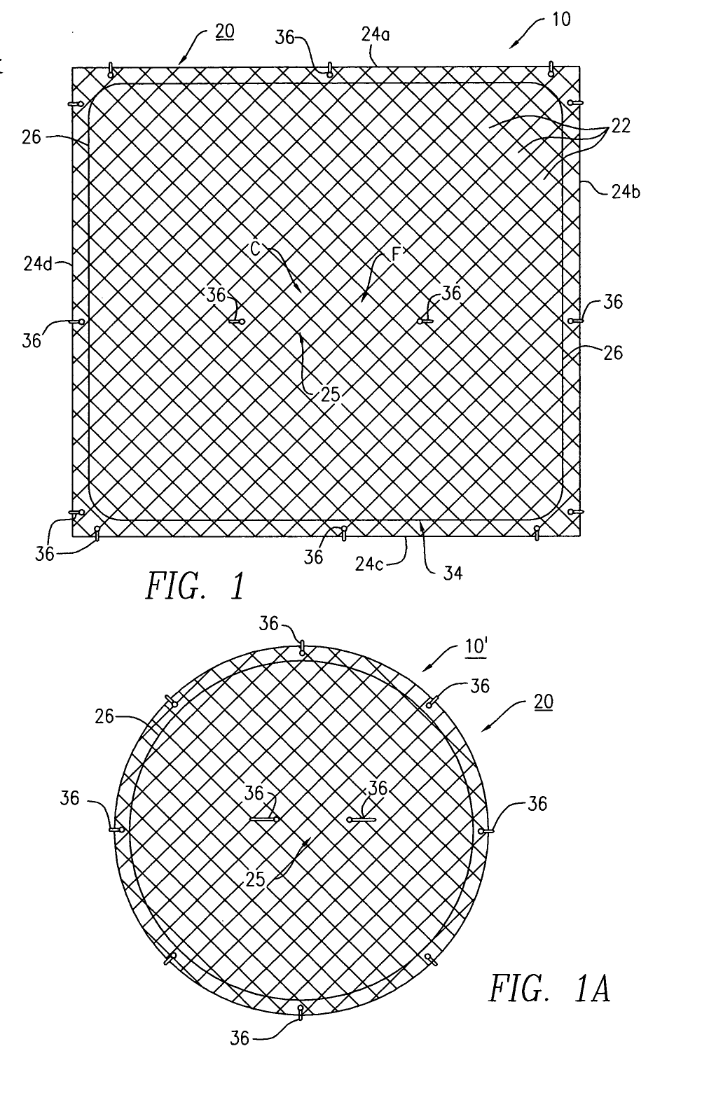

The biodegradable, two dimensional flat leaf collection woven net 10 and its component parts of the preferred embodiment of the present invention is represented in detail by FIGS. 1 through 8 of the patent drawings. The biodegradable flat leaf collection woven net 10 is used for the collection and disposal of fallen leaves 12 from a tree 13 being collected on the lawn/ground 14 of a user's home or commercial building property, etc.

As shown in FIGS. 1 through 3 of the drawings, the two dimensional leaf collection woven net 10 includes a substantially square-shape mesh net 20 having a plurality of spaced-apart mesh openings/net holes 22 being spaced-apart in a range of 1/2 inch by ½ inch square to 1½ to 1½ inch square with a preferable mesh opening 22 of 1 inch by 1 inch square for preventing leaf 12 loss from mesh net 20. The square-shaped mesh net 20 includes an outer perimeter edging 24a, 24b, 24c and 24d. In an alternate design, mesh net 20 of woven net 10′ is round shaped, as depicted in FIG. 1A.

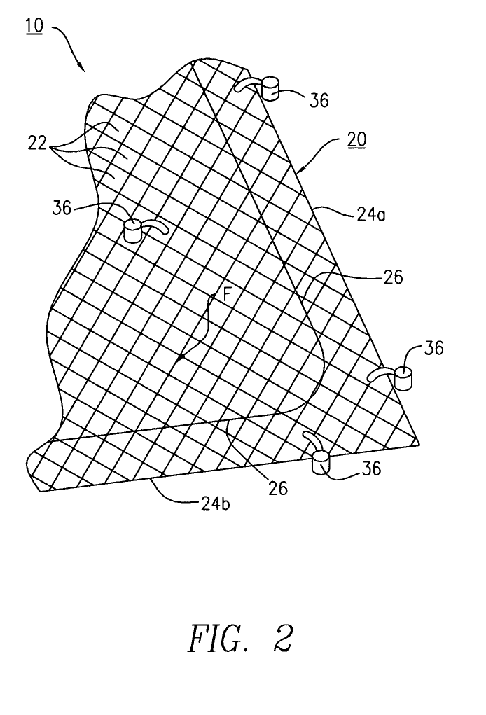

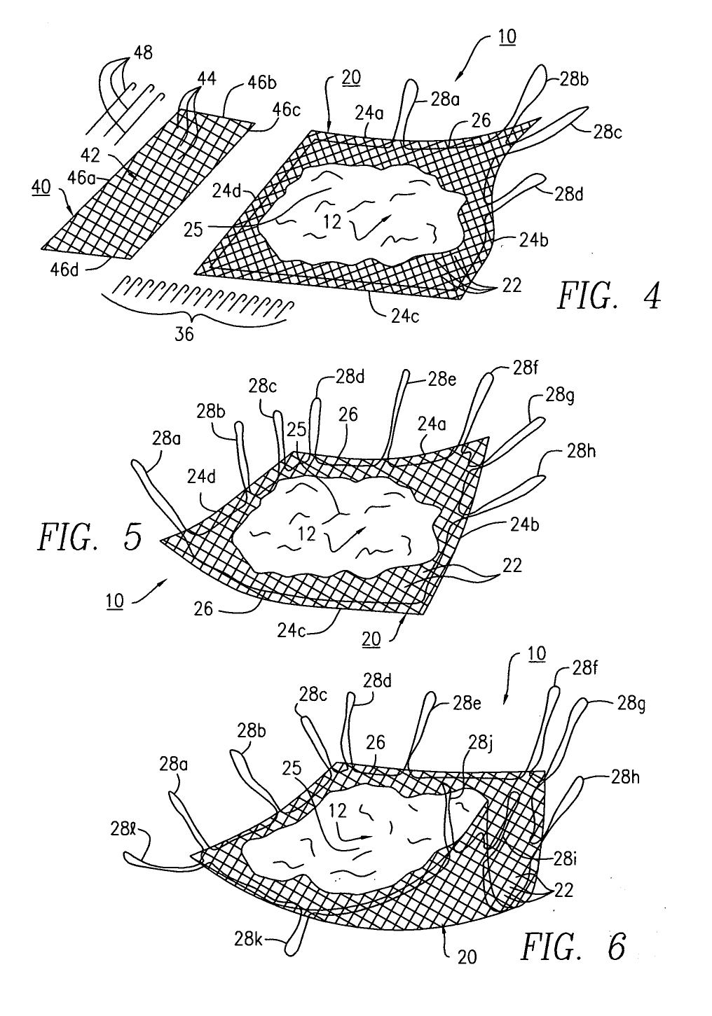

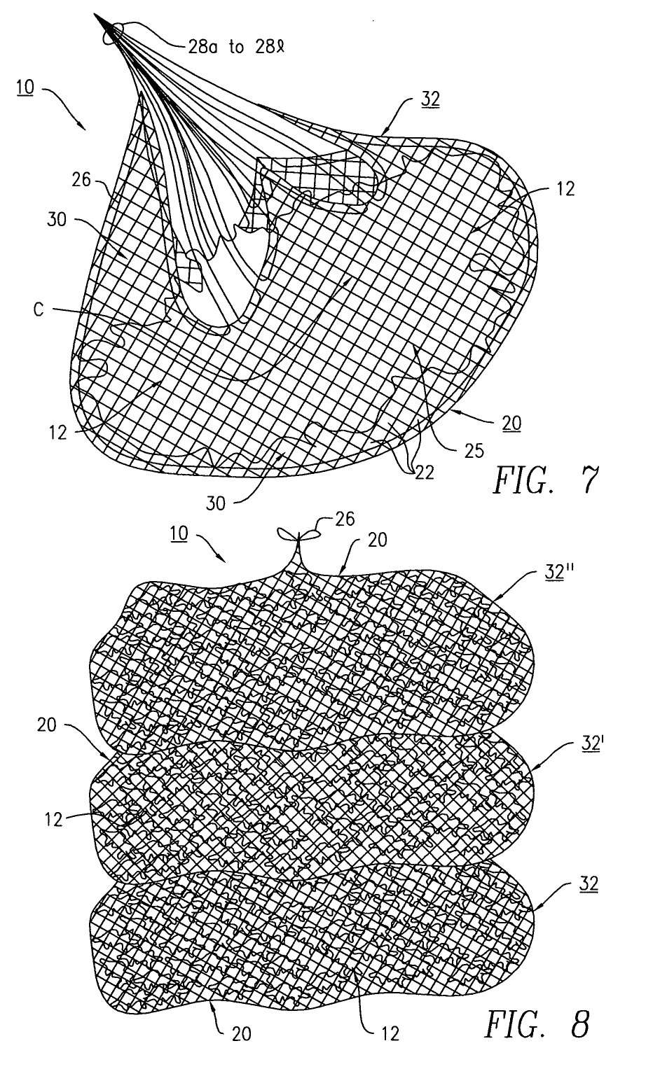

As shown in FIGS. 1 and 2, the mesh openings 22 along the outer perimeter edging/outer periphery 24a to 24d includes a continuous pulling strand 26 extending along the outer periphery 24a to 24d for allowing a plurality of strand sections 28a to 28l when pulled tight by the user (see FIGS. 4 to 8) to harvest all of the leaves 2 within an interior compartment 30 of a woven net disposable bag 32 in the collected configuration (see FIGS. 6 and 7). The continuous pulling strand 26 is a different color 34 from that of the woven net 20. The color 34 of the continuous pulling strand is in red, yellow, orange, black, blue, white or other bright colors in order to easily identify the continuous pulling strand 26 when the user needs to pull the various strand sections 28a to 28l together in the process of collecting and harvesting the fallen leaves 12.

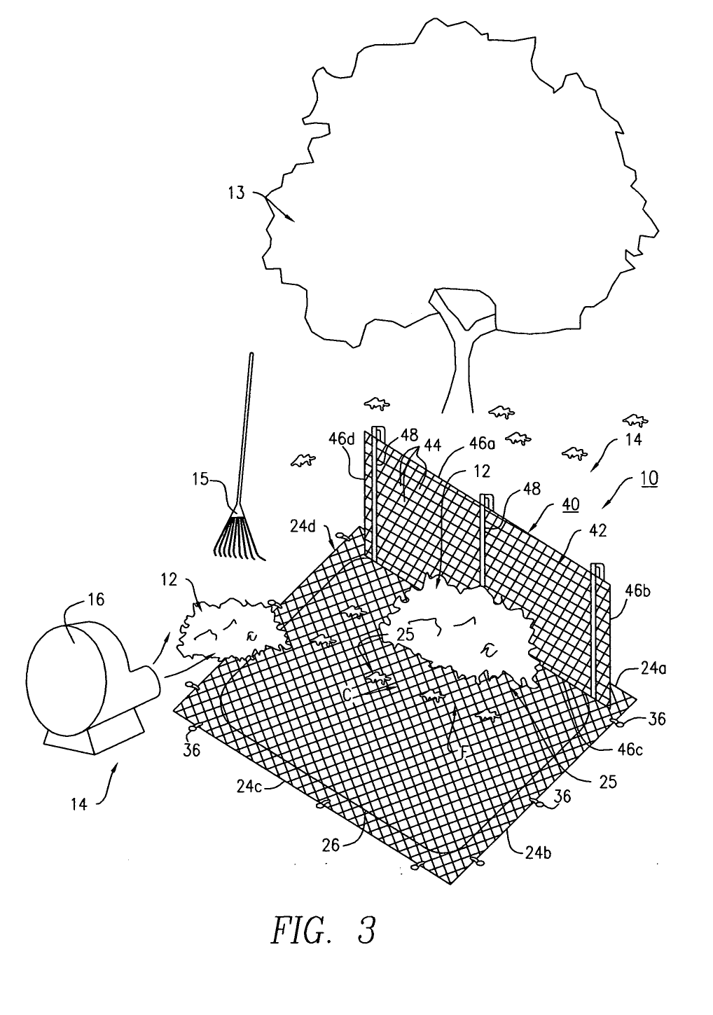

The outer periphery 24a to 24d of the mesh net 20 includes a plurality of net pegs 36 for securing the outer periphery 24a to 24d of the woven mesh net 20, as well as the center C of the mesh net 20 to the ground/lawn 14 in order to rake and collect by a user a multitude of fallen leaves 12 onto a flat area F of the woven mesh net 20 in starting the collection process, a shown in FIGS. 1 and 3 of the drawings. The net peg 36 is substantially J-shaped and made from durable plastic.

The mesh net 20 and the continuous pulling strand 26 is made from biodegradable fiber materials such as jute, hemp, abaca cotton, wood fibers, plant fibers and combinations thereof. The biodegradability of the leaf collection woven net 10 assures the woven net disposable bag 32, after collection and brought to a compost heap, will eventually form a mulch in which the leaf collection woven net 10 will dissolve into the mulch.

The square-shaped mesh net 20 is made in various sizes such as 7 feet by 7 feet, 8½ feet by 8½ feet and 10 feet by 10 feet. The 7 feet by 7 feet leaf collection woven 10 has a 60 gallon capacity for holding approximately 40 pounds of leaves 12 within its interior compartment 30 of the woven net disposable bag 32 when it is in the fully-assembled-state, as shown in FIGS. 6 to 8 of the drawings. The 8½ feet by 8½ feet leaf collection woven net 10 has an 80 gallon capacity for holding approximately 50 pounds of leaves 12 within its interior compartment 30 of the woven net disposable bag 32 when it is in the fully assembled state, as shown in FIGS. 6 to 8 of the drawings. The 10 feet by 10 feet leaf collection woven net 10 has a 100 gallon capacity for holding approximately 60 pounds of leaves 12 within its interior compartment 30 of the woven net disposable bag 32 when its is in the fully assembled state, as shown in FIGS. 6 to 8.

In an alternate design configuration, as shown in FIG. 3, the leaf collection woven net 10 further includes a leaf blocking net 40 for preventing the blowing away of additional or stray leaves 12 on the flat area F of woven mesh net 20 when using a gas leaf blower or an electric air leaf blower 16 during leaf 12 collection. The leaf blocking net 40 includes a substantially rectangularly-shaped woven mesh net 42 having a plurality of spaced-apart mesh openings/net holes 44 being spaced-apart in a range of ½ inch by ½ inch square to 1½ inch by 1½ inch square with a preferable mesh opening 44 of 1 inch by 1 inch square for preventing leaf 12 loss from woven mesh net 42. The rectangularly-shaped mesh net 42 includes an outer perimeter edging 46a, 46b, 46c and 46d. The leaf blocking net 40 is also made of biodegradable fiber materials such as jute, hemp, abaca, cotton, wood fibers, plant fibers and combinations thereof. The leaf blocking net 40 is vertically positioned and oriented along its perimeter edge 46c adjacent to one of the perimeter edges 24a to 24d of woven mesh net 20, as depicted in FIG. 3, using a plurality of net fastening poles 48. The net fastening poles 48 are made of durable plastic and are two feet in height by ¼ inch in diameter. The leaf blocking net 40 has a height of 1½ feet and a length of 5 feet.

### OPERATION OF THE PRESENT INVENTION

In operating the leaf collection woven net 10 of the present invention, as shown in FIGS. 1 and 3 to 8, the following operational steps are as follows. Initially, after the grass has been cut in the autumn and before the leaves 12 begin to fall from tree 13 (See FIG. 3), place and affix the outer periphery 24a to 24d and the center area 25 of woven mesh net 20 on the lawn/ground 14 at one or more desired locations using a plurality of net pegs 36 in order to hold and secure the leaf collection woven net 10 to the lawn 14, as shown in FIGS. 1 and 3 of the drawings. Most of the leaves 12 from tree 13 should fall directly onto the leaf collection woven net 10 at their various locations on lawn 14. Any additional or stray leaves 12 are collected and harvested onto the woven mesh net 20 by raking using a rake 15, or by air blowing them using a leaf air blower 16 by the user, as shown in FIG. 3 of the drawings. When using a gas leaf blower 16, the user places and vertically erects the leaf blocking net 40 along one of the perimeter edges 24a, 24b, 24c or 24d of woven mesh net 20 or towards the center 25 of woven mesh net 20 using the net fastening poles 48 in an L-shaped configuration, as shown in FIG. 3 of the drawings, for preventing the blowing away of collected leaves 12 from the flat area F of woven mesh net 20.

After the collection of all fallen leaves 12 from lawn 14, the user now removes the leaf blocking net 40 and the net fastening poles 48, from the perimeter edge 24a, 24b, 24c or 24d of woven mesh 20. Next, the user pulls the net pegs 36 from the various locations along the outer periphery 24 to 24d, as well as the center area C of woven mesh net 20 such that the user will be able to collect fallen leaves 12 within the woven mesh net 20.

The user now pulls the various strand sections 28a to 28t of the continuous pulling strand 26 along the outer periphery 24a to 24d of woven mesh net 20 in order to harvest and collect all of the fallen leaves 12 within the interior compartment 30 of the formed woven net disposable bag 32, as shown in FIGS. 4 to 6 of the drawings. The user now collects the full disposable bags 32, 32′ and 32″ and piles and stacks them on top of each other for each collection by the municipal collection department, as shown in FIG. 8 of the drawings.

### ADVANTAGES OF THE PRESENT INVENTION

Accordingly, an advantage of the present invention is that it provides for a leaf collection woven net for the collection of fallen leaves that has a pulling strand for pulling a strand section at various locations about outer periphery of a woven mesh net that forms a disposable woven net bag having fallen leaves within an interior compartment therein.

Another advantage of the present invention is that it provides for a leaf collection woven net that has a continuous pulling strand being a different color from that of the woven mesh net in order to easily identify the continuous pulling strand when the user needs to pull the various strand sections together in the process of collecting and harvesting the fallen leaves.

Another advantage of the present invention is that it provides for a leaf collection woven net that is made from biodegradable materials such as jute, hemp, abaca, cotton, wood fibers, plant fibers and combinations thereof.

Another advantage of the present invention is that it provides for a leaf collection woven net that uses a vertically oriented leaf blocking net in combination with the woven net for preventing the blowing away of additional or stray leaves o the woven net when using a gas leaf blower or an electric air leaf blower during leaf collection.

Another advantage of the present invention is that it provides for a leaf collection woven net when in a fully assembled state having fallen leaves therein wherein each of the disposable woven net bags are stackable with each other.

Another advantage of the present invention is that it provides for a leaf collection woven net that is easy to assemble and use with only one moving part (the continuous pulling strand) for harvesting of the fallen leaves on the woven mesh net.

Another further advantage of the present invention is that it provides for a leaf collection woven net that can be mass produced in an automated and economical manner and is readily affordable by the user.

A latitude of modification, change, and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

1. (canceled)

2. A two-dimensional flat woven net for collecting leaves, comprising:
a) a two-dimensional flat woven net having a mesh structure and having an outer periphery;
b) said woven net having mesh openings of ½×″½″ to 1½″×1½″;
c) said woven net being formed of biodegradable jute material;
d) a continuous pulling strand extending about said outer periphery of said woven net; and
e) said continuous pulling strand for pulling a strand section of said continuous pulling strand at various locations about said outer periphery to form said flat woven net into a disposable woven net bag for carrying and transporting collected leaves.

3. A leaf collection woven net in accordance with claim 2, wherein said woven net has a substantially square-shape or round shape.

4. A leaf collection woven net in accordance with claim 3, wherein said square-shaped woven net is seven (7) feet by seven (7) feet in size having a 60 gallon capacity for holding approximately 40 pounds of leaves.

5. A leaf collection woven net in accordance with claim 3, wherein said square-shaped woven net is eight and half (8½) feet by eight and half (8½) feet in size having an 80 gallon capacity for holding approximately 50 pounds of leaves.

6. A leaf collection woven net in accordance with claim 3, wherein said square-shaped woven net is ten (10) feet by ten (10) feet in size having a 100 gallon capacity for holding approximately 60 pounds of leaves.

7. A leaf collection woven net in accordance with claim 2, wherein said continuous pulling strand is a different color from said woven net for ease of selecting said strand sections of said colored continuous pulling strand formed of jute material.

8. A leaf collection woven net in accordance with claim 7, wherein said color of said continuous pulling strand is red, yellow, orange, black, blue, white or other bright colors.

9. A leaf collection woven net in accordance with claim 2, where in said outer periphery of said woven net includes a plurality of net pegs for securing said outer periphery of said woven net to the ground in order to rake a multitude of fallen leaves onto a flat area of said flat woven net.

10. A leaf collection woven net in accordance with claim 2, wherein said continuous pulling strand is made from biodegradable jute material.

11. A two-dimensional flat woven net for collecting leaves, comprising:
a) a two-dimensional flat woven net having a mesh structure and having an outer periphery;
b) said woven mesh net having mesh openings of ½″×½″ to 1½″×1½″;
c) said woven net being formed of a biodegradable fiber material;
d) a continuous pulling strand extending about said outer periphery of said woven net; and
e) said continuous pulling strand for pulling a strand section of said continuous pulling strand at various locations about said outer periphery to form said flat woven net into a disposable woven net bag for carrying and transporting collected leaves.

12. A leaf collection woven net in accordance with claim 11, wherein said biodegradable fiber material is selected from a group consisting of jute, hemp, abaca, cotton, wood fibers, plant fibers and combinations thereof.

13. A leaf collection woven net in accordance with claim 11 wherein said woven net has a substantially square-shape or round shape.

14. A leaf collection woven net in accordance with claim 13, wherein said square-shaped woven net is seven (7) feet by seven (7) feet in size having a 60 gallon capacity for holding approximately 40 pounds of leaves.

15. A leaf collection woven net in accordance with claim 13, wherein said square-shaped woven net is eight and a half (8½) feet by eight and a half (8½) feet in size having an 80 gallon capacity for holding approximately 50 pounds of leaves.

16. A leaf collection woven net in accordance with claim 13, wherein said square-shaped woven net is (10) feet by ten (10) feet in size having a 100 gallon capacity for holding approximately 60 pounds of leaves.

17. A leaf collection woven net in accordance with claim 11, wherein said continuous pulling strand is a different color from said woven net for ease of selecting said strand sections of said colored continuous pulling strand formed of said biodegradable fiber material.

18. A leaf collection woven net in accordance with claim 11, wherein said outer periphery of said woven net includes a plurality of net pegs for securing said outer periphery of said woven net to the ground in order to rake a multitude of fallen leaves onto a flat area of said flat woven net.

19. A leaf collection woven net in accordance with claim 11, wherein said continuous pulling strand is made from said biodegradable fiber material.

20. A leaf collection woven net in accordance with claim 11, wherein said woven net includes a leaf blocking net for preventing the blowing away of leaves from a flat area of said woven mesh net.

21. A leaf collection woven net in accordance with claim 20, wherein said leaf blocking net includes a plurality of net fastening poles for assembling said leaf blocking net adjacent to the edge of said woven mesh net to form an L-shaped structure.
